(19) United States
(12) Patent Application Publication
(10) Pub. No.: US 2017/0168592 A1
(43) Pub. Date: Jun. 15, 2017

(54) SYSTEM AND METHOD FOR OPTICAL TRACKING

(71) Applicant: Volodymyr Mishyn, Puerta Plata (DO)

(72) Inventor: Volodymyr Mishyn, Puerta Plata (DO)

(21) Appl. No.: 15/379,295

(22) Filed: Dec. 14, 2016

Related U.S. Application Data
(60) Provisional application No. 62/267,074, filed on Dec. 14, 2015.

(51) Int. Cl. G06F 3/03; G06F 3/01

(52) U.S. Cl. CPC G06F 3/0304; G06F 3/011; H04N 17/002

(57) ABSTRACT

Disclosed is an optical tracking system. The optical tracking system includes a headset configured to be worn by a user. Further, the optical tracking system includes at least one camera mounted on the headset. Yet further, the optical tracking system includes at least one controller comprising a plurality of markers, wherein the at least one controller is configured to receive at least one input. Moreover, the optical tracking system includes an image processing module configured to process at least one image of the at least one controller to detect at least one of a position and an orientation of the at least one controller, wherein the at least one image is captured by the at least one camera.

### CROSS-REFERENCE TO RELATED APPLICATIONS

This application claims priority from a provisional patent application No. 62/267,074, filed on Dec. 14, 2015, titled “Color-Coded Optical Tracking System” which is incorporated herein by reference in its entirety.

### FIELD OF THE DISCLOSURE

Generally, the disclosure relates to optical tracking. More specifically, the disclosure relates to a method and system for optical tracking for tracking position, movement and inclination angles of a controller.

### BACKGROUND

Tracking and pointing devices and applications allow users to interact with computing devices in an intuitive manner. Optical tracking systems rely on some type of emission, reflection, and detection of light, which is translated, for example, into movement of a cursor within the context of a monitor or other display.

Generally, optical tracking systems use one or more cameras mounted on fixed bearings to observe user's movements and gestures from a fixed point. When using these systems, the user could break the straight line of sight between the camera and markers on a controller carried by a user. As the cameras are not able to observe the controller, these systems are unable to continue tracking the position and orientation of the controller.

Further, optical tracking systems lack compatibility with portable devices like smart phones and tablets. Therefore, they are unable to use built-in cameras of these portable devices. Accordingly, peripheral cameras may be used, but that will increase the overall cost of the system. The latency will also increase, as the video streams from the peripheral cameras would be transferred through slow cable connections or through even slower wireless connections.

Yet further, optical tracking systems often suffer from high environment light level; for example, the light produced by the sun or artificial lighting. This leads to inaccurate tracking.

Moreover, optical tracking systems normally use video streaming from cameras to track the position and orientation of markers in a set space. In addition to this, the transmission of control signals (such as, the state of the buttons and operating modes) is carried over other communication channel, such as Bluetooth, Wi-Fi and Infrared. This often increases the cost of the system as well as the latency while in use.

Therefore, there is a need for improved methods, apparatus and devices to provide improved optical tracking system for tracking position, movement and inclination angles of a controller.

### SUMMARY

Disclosed is an optical tracking system. The optical tracking system includes a headset configured to be worn by a user. Further, the optical tracking system includes at least one camera mounted on the headset. Yet further, the optical tracking system includes at least one controller comprising a plurality of markers, wherein the at least one controller is configured to receive at least one input. Moreover, the optical tracking system includes an image processing module configured to process at least one image of the at least one controller to detect at least one of a position and an orientation of the at least one controller, wherein the at least one image is captured by the at least one camera.

According to another aspect, an optical tracking system is disclosed. The optical tracking system includes a headset configured to be worn by a user. Further, the optical tracking system includes at least one camera mounted on the headset. Yet further, the optical tracking system includes at least one controller comprising a plurality of lasers, wherein the at least one controller is configured to receive at least one input. Moreover, the optical tracking system includes an image processing module configured to process at least one image of at least one of the at least one controller and a reflection of light emitted by the plurality of lasers on a surface, wherein processing of the at least one image is performed to detect at least one of a position and an orientation of the at least one controller, wherein the at least one image is captured by the at least one camera.

Further disclosed is a method of optically tracking at least one controller. The method includes receiving, using at least one camera, at least one image of the at least one controller comprising a plurality of light emitters arranged in a predetermined spatial pattern. Further, the method includes processing, using an image processing module, the at least one image to detect at least one of a position and an orientation of the at least one controller, wherein the processing is based on analysis of a projection of the predetermined spatial pattern in the at least one image. Yet further, the method includes processing, using the image processing module, the at least one image to determine an operational state of the at least one controller, wherein the plurality of light emitters is configured to emit light corresponding to a plurality of colors, wherein the operational state is encoded in the plurality of colors.

The disclosed optical tracking system allows tracking of the position, movement and inclination angles of a controller. Also, the optical tracking system transmits commands from the controller to the headset worn by the user and then, if necessary, to a computer or any other signal processing device. Mounting the camera to the user's headset makes it impossible to break line of sight between the camera and the markers on the controller. Further, the optical tracking system provides compatibility with the built-in camera of mobile devices. Moreover, the optical tracking system uses a filter to reduce ambience light and to view specific wavelengths. The markers are arranged into patterns, and pattern detection may be used to produce accurate and noise free results. Further, color-coded patterns may be used to transmit control signals in the same video stream that is used to determine the position and orientation of the controller, thereby reducing the latency and cost of the system.

The disclosed optical tracking system may be used in various applications, such as, but not limited to, controllers of the virtual reality and augmented reality, simulators, and training equipment. Further, the optical tracking system may be used in the field of entertainment, education, sports, medicine, military, manufacturing, and for personnel trainings.

### BRIEF DESCRIPTION OF DRAWINGS

FIG. 1A illustrates a schematic diagram showing a top-view of an optical tracking system, in accordance with an embodiment.

FIG. 1B illustrates a schematic diagram showing a side-view of the optical tracking system of FIG. 1A.

FIG. 1C illustrates a schematic diagram showing a front-view of markers of the optical tracking system of FIG. 1A.

FIG. 2 illustrates a schematic diagram showing a top-view of an optical tracking system, in accordance with an embodiment.

FIGS. 3A-F illustrate schematic diagrams showing side-views of a controller of an optical tracking system, in accordance with an embodiment.

FIGS. 3G-I illustrate schematic diagrams showing top-views of a controller of an optical tracking system, in accordance with an embodiment.

FIGS. 4A-C illustrate schematic diagrams showing side-views of light emitters of a controller of an optical tracking system, in accordance with an embodiment.

FIG. 5A illustrates a schematic diagram showing a top-view of an optical tracking system, in accordance with an embodiment.

FIGS. 5B-C illustrate schematic diagrams showing front-views of markers on the controllers of the optical tracking system of FIG. 5A.

FIG. 6 illustrates a schematic diagram showing a side-view of an optical tracking system, in accordance with an embodiment.

FIG. 7 illustrates a schematic diagram showing a top-view of an optical tracking system, in accordance with an embodiment.

FIG. 8 illustrates a schematic diagram showing a side-view of an optical tracking system, in accordance with an embodiment.

FIG. 9 illustrates a schematic diagram showing a side-view of an optical tracking system, in accordance with an embodiment.

FIG. 10 illustrates a flowchart of a method of optically tracking a controller, in accordance with an embodiment.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary.

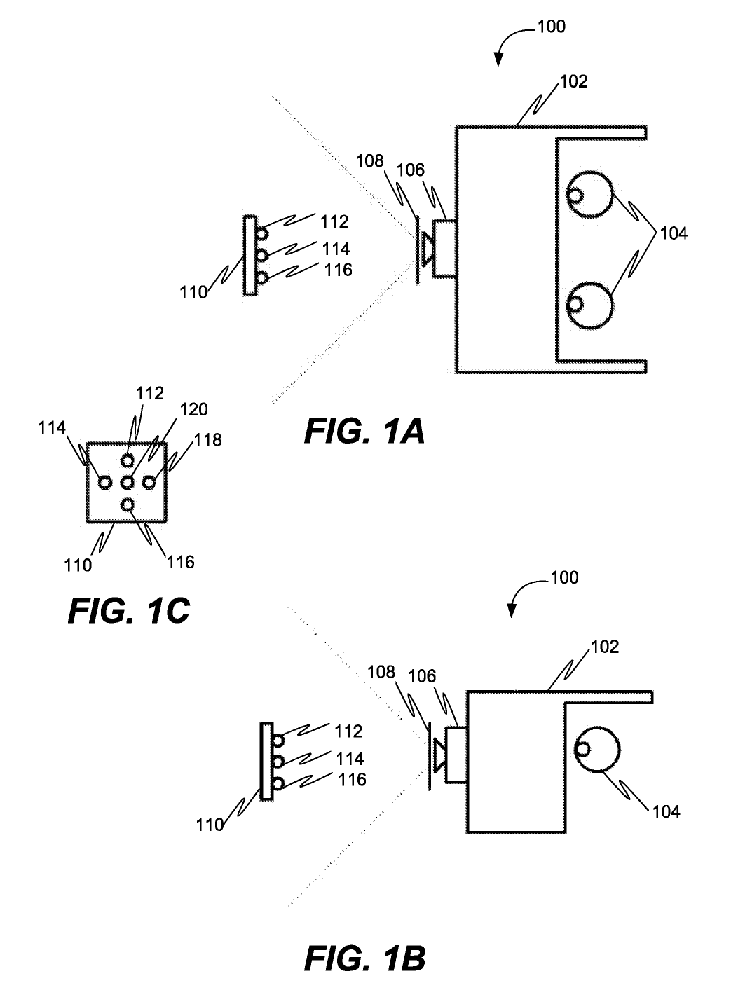

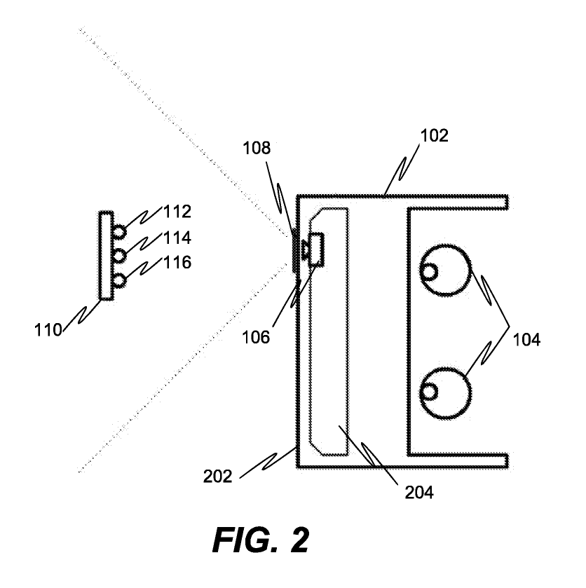

FIG. 1A illustrates a schematic diagram showing a top-view of an optical tracking system 100, in accordance with an embodiment. FIG. 1B illustrates a schematic diagram showing a side-view of the optical tracking system 100. The optical tracking system 100 includes a headset 102 configured to be worn by user. For example, user's eyes 104 may be positioned behind the headset 102. The optical tracking system 100 further includes a camera 106 mounted on the headset 102. The camera 106 may include one or more CCD Cameras, CMOS Cameras, SIMD WRD Cameras, Live-MOS Cameras, Super CCD Cameras, or any other device that allows capturing of an image. Further, an optical filter 108 may be positioned optical path of the camera 106. The optical filter 108 may be configured to reduce brightness of ambient light. The optical filer 108 may also he used to allow only a certain frequency of the light spectrum to pass through to enter the camera 106. In an embodiment, a back cover 202 of the headset 102 may be made of material, which provides the filter functionality, as shown in FIG. 2. FIG. 2 illustrates a schematic diagram showing a top-view of the optical tracking system 100, in accordance with an embodiment.

The optical tracking system 100 further includes a controller 110 comprising multiple markers 112420. FIG. 1C illustrates a schematic diagram showing a front-view of the controller 110 comprising the multiple markers 112-120. The controller 110 is configured to receive one or more inputs from he user. The controller 110 may be one or more of a gamepad, a joystick, a paddle, a steering wheel, a motion controller and a gun.

The optical tracking system 100 further includes an image processing module (not shown) configured to process one or more images of the controller 110 to detect one or both of a position and an orientation of the controller 110. The image processing module may be further configured to detect at least one gesture performed using the controller 110. The image processing module may also be configured to perform self-calibration of one or both of brightness and color associated with the one or more images.

The one or more images of the controller 110 may be captured by the camera 106. The multiple markers 112 may be arranged on the controller 110 in a predetermined spatial pattern, such that the image processing module is able to accurately detect one or both of the position and the orientation of the controller 110, based on an analysis of the one or more images, wherein the one or more images include a projection of the predetermined spatial pattern. For example, as shown in FIG. 1C, the markers 112-120 may be placed in a predetermined spatial pattern that includes four markers 112-118 are arranged around the central marker 120.

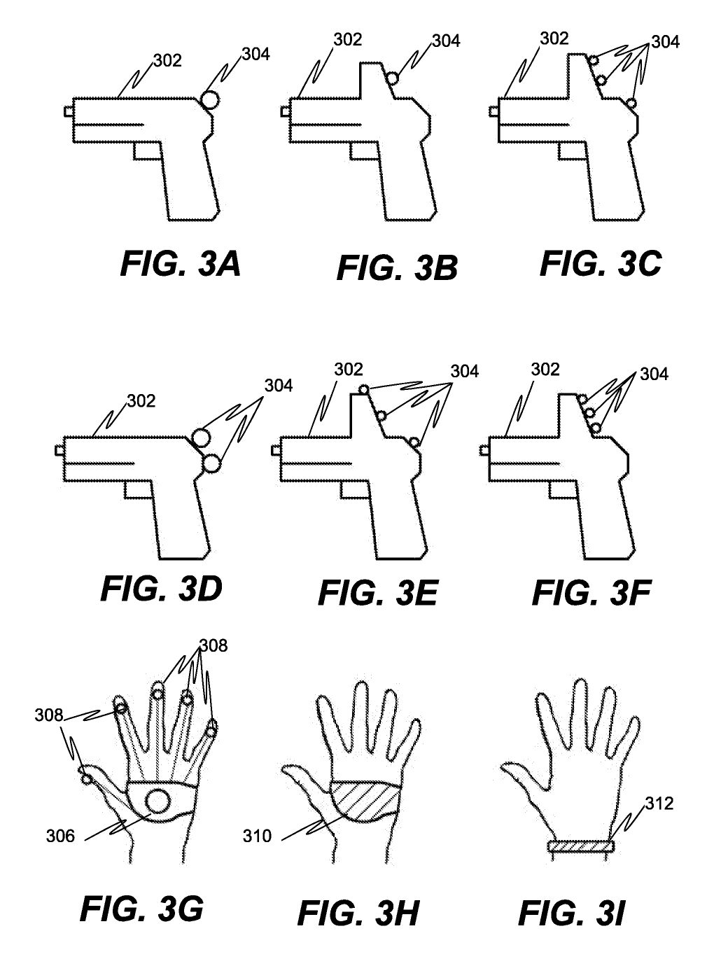

In another example, the controller 110 may be a gun 302 as shown in FIGS. 3A-F. FIGS. 3A-F illustrate schematic diagrams showing side-views of the gun 302. Accordingly, multiple markers 304 may be arranged in various configurations on the gun 302 as shown in FIGS. 3A-F. Further, the multiple markers 304 may be arranged on the gun 302 in a manner that enables the multiple markers 304 to be present within a field of view of a camera (such as the camera 106) while the gun 302 is operated by a user. In yet another example, the controller 110 may be a wearable device worn on a hand of a user. FIGS. 3G-I illustrate schematic diagrams showing top-views of wearable devices worn on the hand of the user. As shown in FIG. 3G, a glove 306 may be used as a controller, wherein the glove 306 may include multiple markers 308 placed on the fingertips. Alternatively, a hand band 310 may be used as a controller, wherein the hand band 310 may have a reflective coating, as shown in FIG. 3H. Further, a wrist band 312 may be used as a controller, as shown in FIG. 3I. The wrist band 312 may include one or more markers or a reflective coating.

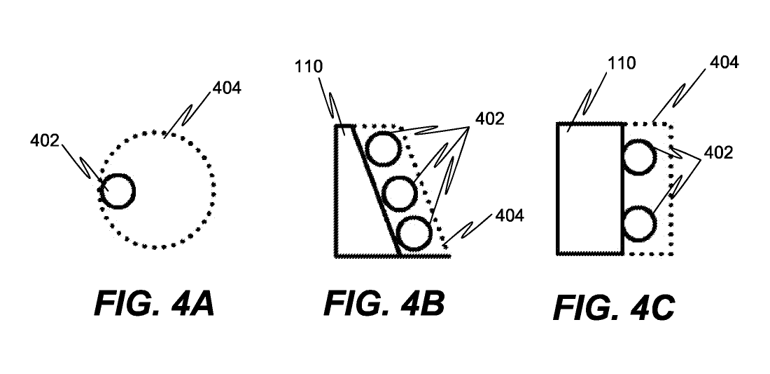

In a further embodiment, the multiple markers may be light emitters, such as, but not limited to, incandescent bulbs, fluorescent bulbs, LED, and OLED. FIGS. 4A-C illustrate schematic diagrams showing side-views of light emitters 402 deployed on the controller 110. The light emitters 402 may be configured to emit light corresponding to multiple colors. The light emitters 402 may also have also light-scattering (or light-collecting) casing 404.

Further, an operational state of the controller 110 may be encoded in the multiple colors, wherein the operational state may include a state of one or more buttons comprised in the controller 110. Therefore, the operational state of the controller 110 may be determined by the image processing module by detecting a change in the light pattern of the light emitters.

Referring back to FIG. 1, the controller 110 may have 4 buttons that may be used by a user to provide input, in an exemplary embodiment. Further, the multiple markers 112-120 may be light emitters 112-120. The light emitters 112, 116 may emit red light, the light emitters 114, 118 may emit green light and the light emitter 120 may emit blue light. Then, the information about operational state of the controller 110 may be encoded such as, if only blue light (the light emitter 120) is turned on, then it is determined that no buttons are pressed. If blue light (the light emitter 120) and upper red light (the light emitter 112) are on, then it is determined that first button is pressed by the user. If blue light (the light emitter 120) and lower red light (the light emitter 116) are on, then it is determined that second button is pressed by the user. If blue light (the light emitter 120) and left green light (the light emitter 114) are on, then it is determined that the third button is pressed by the user. If blue light (the light emitter 120) and right green light (the light emitter 118) are on, then it is determined that the fourth button is pressed by the user. If no light is visible, then it is determined that the controller 110 is turned off, or it is outside of the camera 106 field of view.

Further, a first set of light emitters may be configured to emit visible light and a second set of light emitters configured to emit infrared light, wherein the camera 106 may be configured to capture each of visible light and infrared light. Further, light emitted by at least one of the first set of light emitters and the second set of light emitters may be based on an operational state of the controller 110. Also, it is possible to combine emitters of visible and infrared light, wherein infrared emitters could be used as a separate channel to transmit data from the controller 110 to the headset 102. The data may be related to the operational state of the controller 110. To transmit the data through infrared channel, any suitable standard or proprietary protocol may be used.

The optical tracking system 100 may further include a storage module configured to store one or both of the position and the orientation of the controller 110, wherein the image processing module is further configured to determine one or both of a predicted position and a predicted orientation based on one or both of the position and the orientation.

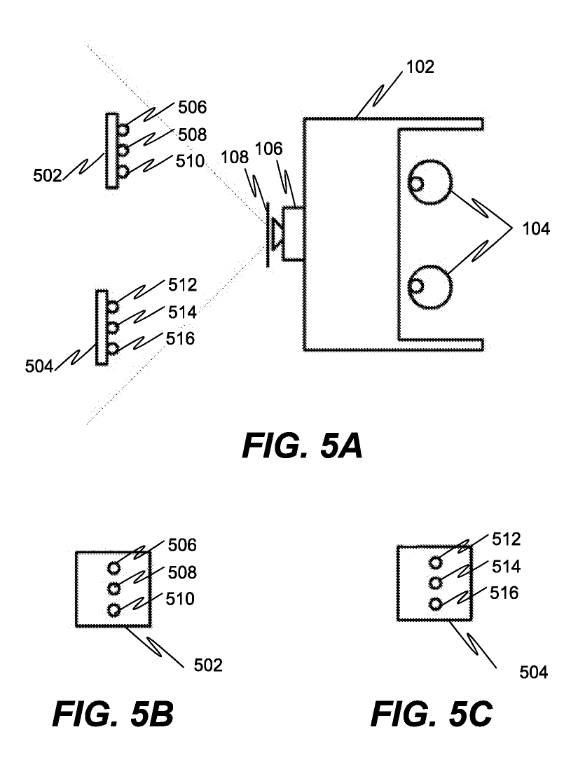

In a further embodiment, two controllers may be used, such as a first controller 502 and a second controller 504, as shown in FIGS. 5A-C. FIG. 5A illustrates a schematic diagram showing a top-view of the optical tracking system 100, in accordance with an embodiment. FIGS. 5B-C illustrate schematic diagrams showing front-views of markers on the controllers 502-504 respectively. The first controller 502 may include a first set of light emitters 506-510 and the second controller 504 includes a second set of light emitters 512-516. The first set of light emitters 506-510 may be configured to emit light corresponding to a first set of colors, wherein the second set of light emitters 512-516 may be configured to emit light corresponding to a second set of colors. For example, the light emitters 506, 510 may emit red light, while the light emitter 508 may emit blue light. Similarly, the light emitters 512,516 may emit green light, while the light emitter 514 may white light. The optical tracking system 100 may track the position of the first controller 502 based finding the blue light emitter 508. Similarly, the optical tracking system 100 may track the position of the second controller 504 based on position of the white light emitter 514. The distance from the first controller 502 to the user maybe calculated based on the size of the color spot of the blue light from the light emitter 508 on the sensor of the camera 106. Similarly, the distance from the second controller 504 to the user maybe calculated based on the size of the color spot of the white light from the light emitter 514 on the sensor of the camera 106. Further, the position of the controller may be found by mapping coordinates of corresponding color spot on the sensor of the camera 106 into the headset's (102) coordinate system. Further, a gesture may be determined by tracking the change in position and orientation of the controllers 502-504. For example, moving a controller (such as one of the controllers 502-504) out the field of view of the camera 106 on the right side may be interpreted as a gesture from the user to turn to the right. Similarly, moving the controller out from the field of view of the camera 106 on the left side may be interpreted as a gesture from the user to turn to the left. Further, the status of the buttons of the controllers 502-504 may be encoded using colors as explained in detail in conjunction with FIGS. 4A-C above.

Further, the first set of light emitters 506-510 may be configured to emit light during a first predetermined time period, wherein the second set of light emitters 512-516 may be configured to emit light during a second predetermined time period. For example, the first set of light emitters 506-510 may be turned on first. Thereafter, the camera 106 reads the pattern displayed by the first set of light emitters 506-510, then the second set of light emitters 512-516 may be turned on and the first set of light emitters 506-510 may be turned off. Here, some additional synchronization may be required, as the camera 106 and the image processing module need information about the exact timings for each of the controllers 502-504 state transmission phases.

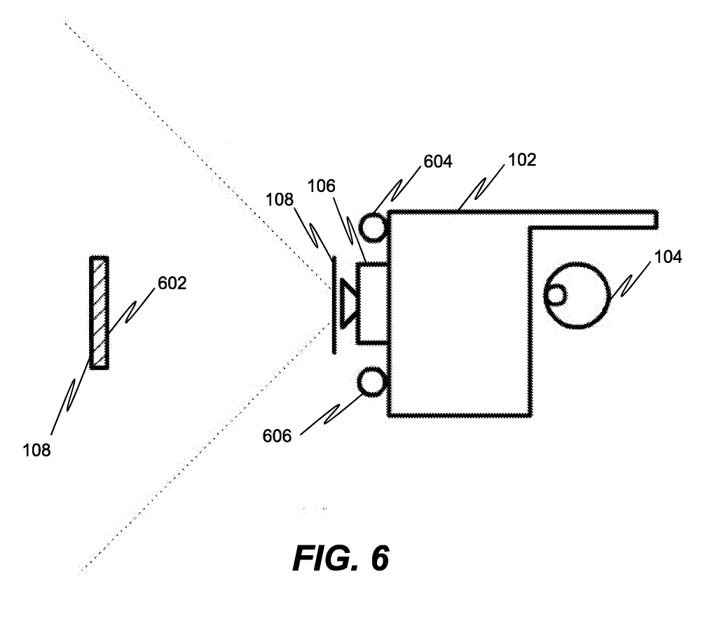

In an alternate embodiment, the multiple markers 112-120 may be one or more light reflectors 602, as shown in FIG. 6. FIG. 6 illustrates a schematic diagram showing a side-view of the optical tracking system 100, in accordance with an embodiment. Further, a reflective coating may be applied to a part or the entire surface of the controller 110. Therefore, the optical tracking system 100 may further include one or more light sources 604-606 configured to provide nation over a field of view of the camera 106. For example, the one or more light sources 604-606 may be mounted on the headset 102. The one or more light sources 604-606 may be configured to provide a uniform illumination in the entire region in which the optical tracking system 100 is designed to track one or both of the position and orientation of the controller 110.

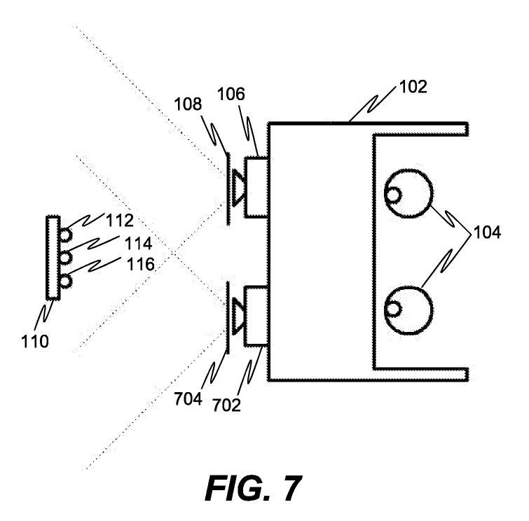

In a further embodiment, multiple cameras 106, 702 may be mounted on the headset 102, as shown in FIG. 7. FIG. 7 illustrates a schematic diagram showing a top-view of the optical tracking system 100, in accordance with an embodiment. An optical filter 704 may be positioned in an optical path of the camera 702. Accordingly, the image processing module may be further configured to detect one or both of the position and the orientation of the controller 110 based on image captured by one or both the cameras 106, 702. The image processing module may use triangulation and depth analyzing algorithms. The multiple cameras 106, 702 may also increase the tracking area and the overall accuracy of the optical tracking system 100.

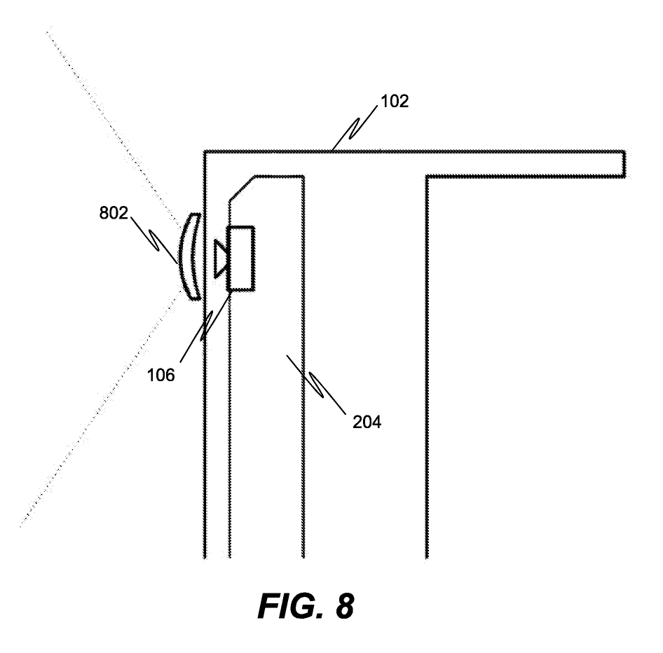

In a yet further embodiment, a diverging lens 802 may be positioned in an optical path of the camera 106, as shown in FIG. 8. FIG. 8 illustrates a schematic diagram showing a side-view of the optical tracking system 100, in accordance with an embodiment. The diverging lens 802 may be configured to increase a field of view of the camera 106.

The optical tracking system 100 may further include a communication interface configured to perform communication with a host computing device, wherein the communication comprises one or both of the position and the orientation of the controller 110. The communication interface may employ any suitable communication technology including, but not limited to Bluetooth, Wi-Fi, Infrared and NFC.

In an alternate embodiment, each of the camera 106 and the image processing module may be comprised in a mobile device, such as, but are not limited to, phones, smartphones, tablet devices, microcomputers, computers and laptops. For example, as shown FIGS. 2 and 8, the headset 102 may include a mobile device 204, with an in-built camera 106 and the image processing module. This reduces the cost of the optical tracking system 100 and also reduces latency (response time), as the mobile devices generally have faster access to the built-in camera, than to the peripheral devices.

In another embodiment, the camera 106 may also include the image processing module. Accordingly, the camera 106 may transmit just the actual position and/or orientation data of the controller 110 via the communication interface to a host computing device, and not the entire video stream. The camera 106 may be connected to the host computing device by cable connection (USB, COM, LPT, SPI, SPP or other protocols) or by any other wireless communication technologies including, but not limited to: Bluetooth, Wi-Fi, NFC, Infrared.

In an embodiment, the image processing module is configured to detect one or both of the position and orientation of a controller from a video stream received from a camera. The image processing module is further configured to correctly distinguish the patterns of the markers on the controllers, to perceive states of the controller. The states of the controller include buttons states and operation modes. The image processing module is further configured to provide noise compensation and movement prediction. The image processing module may also include calibration algorithms to adjust to light pattern brightness and exact color values, as different image capturing devices may translate light of same wavelengths to different RGB values.

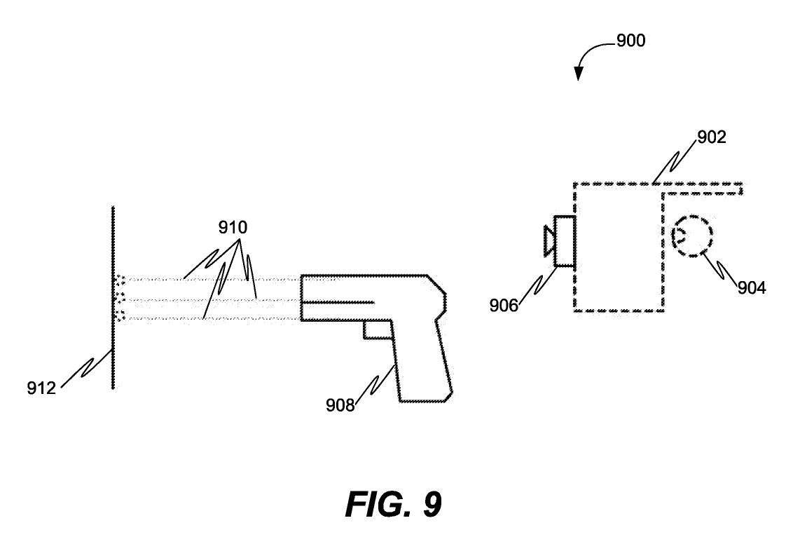

FIG. 9 illustrates a schematic diagram showing a side-view of an optical tracking system 900, in accordance with an embodiment. The optical tracking system 900 includes a headset 902 configured to be worn by a user, such that the user's eyes 904 may be positioned behind the headset 902. The optical tracking system 900 further includes one or more cameras 906 mounted on the headset 902. The optical tracking system 900 further includes one or more controllers 908 comprising multiple lasers 910, wherein the one or more controllers 908 are configured to receive one or more inputs from the user. The optical tracking system 900 further includes an image processing module (not shown) configured to process one or more images of the one or more controllers 908 and a reflection of light emitted by the multiple lasers 910 on a surface 912, wherein processing of the one or more images is performed to detect one or both of a position and an orientation of the one or more controllers 908, wherein the one or more images are captured by the one or more cameras 906. For example, the surface 912 may be a part of a wall, ceiling, floor, furniture, projection screen and a TV.

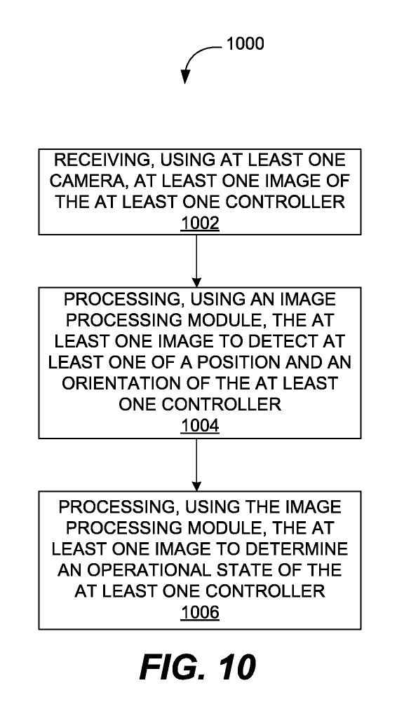

FIG. 10 illustrates a flowchart of a method 1000 of optically tracking the controller 110, in accordance with an embodiment. At 1002, the method 1000 includes receiving, using the camera 106, one or more images of the controller 110 comprising multiple light emitters 112-120 arranged in a predetermined spatial pattern.

At 1004, the method 1000 includes processing, using an image processing module, the one or more images to detect one or both of a position and an orientation of the controller 110, wherein the processing is based on analysis of a projection of the predetermined spatial pattern in the one or more images.

At 1006, the method 1000 includes processing, using the image processing module, the one or more images to determine an operational state of the controller 110, wherein the plurality of light emitters 112-120 may be configured to emit light corresponding to multiple colors, wherein the operational state is encoded in the multiple colors.

Although the invention has been explained in relation to its preferred embodiment, it is to be understood that many other possible modifications and variations can be made without departing from the spirit and scope of the invention. For example, the number of light emitters, the location of light emitters, number of buttons on the controllers, the encoding of buttons using colors may differ as per specific applications.

We claim:

1. An optical tracking system comprising:
a. a headset configured to be worn by a user;
b. at least one camera mounted on the headset;
c. at least one controller comprising a plurality of markers, wherein the at least one controller is configured to receive at least one input; and
d. an image processing module configured to process at least one image of the at least one controller to detect at least one of a position and an orientation of the at least one controller, wherein the at least one image is captured by the at least one camera.

2. The optical tracking system of claim 1, wherein the plurality of markers comprises a plurality of light emitters.

3. The optical tracking system of claim 1, wherein the plurality of markers comprises a plurality of light reflectors.

4. The optical tracking system of claim 3 further comprising at least one light source configured to provide illumination over a field of view of the at least one camera.

5. The optical tracking system of claim 4, wherein the at least one light source is mounted on the headset.

6. The optical tracking system of claim 1, wherein the at least one camera comprises a plurality of cameras, wherein the image processing module is further configured to detect at least one of the position and the orientation of the at least one controller based on triangulation.

7. The optical tracking system of claim 1 further comprising an optical filter positioned in an optical path of the at least one camera, wherein the optical filter is configured to reduce brightness of ambient light.

8. The optical tracking system of claim 1, wherein the plurality of markers is arranged on the at least one controller in a predetermined spatial pattern, wherein the image processing module is configured to detect at least one of the position and the orientation of the at least one controller based on an analysis of the at least one image comprising a projection of the predetermined spatial pattern.

9. The optical tracking system of claim 8, wherein the plurality of markers is arranged on the at least one controller in a manner that enables the plurality of markers to be present within a field of view of the at least one camera while the at least one controller is operated by a user.

10. The optical tracking system of claim 2, wherein the plurality of light emitters is configured to emit light corresponding to a plurality of colors.

11. The optical tracking system of claim 10, wherein an operational state of the at least one controller is encoded in the plurality of colors.

12. The optical tracking system of claim 11, wherein the operational state comprises a state of at least one button comprised in the at least one controller.

13. The optical tracking system of claim 10, wherein the at least one controller comprises a first controller and a second controller, wherein the first controller comprises a first set of light emitters of the plurality of light emitters and the second controller comprises a second set of light emitters of the plurality of light emitters, wherein the first set of light emitters are configured to emit light corresponding to a first set of colors, wherein the second set of light emitters are configured to emit light corresponding to a second set of colors.

14. The optical tracking system of claim 2, wherein the at least one controller comprises a first controller and a second controller, wherein the first controller comprises a first set of light emitters of the plurality of light emitters and the second controller comprises a second set of light emitters of the plurality of light emitters, wherein the first set of light emitters are configured to emit light during a first predetermined time period, wherein the second set of light emitters are configured to emit light during a second predetermined time period.

15. The optical tracking system of claim 1, wherein the image processing module is further configured to detect at least one gesture performed using the at least one controller.

16. The optical tracking system of claim 1 further comprising a diverging lens positioned in an optical path of the at least camera, wherein the diverging lens is configured to increase a field of view of the at least one camera.

17. The optical tracking system of claim 1 further comprising a communication interface configured to perform communication with a host computing device, wherein the communication comprises at least one of the position and the orientation of the at least one controller.

18. The optical tracking system of claim 1, wherein each of the at least one camera and the image processing module is comprised in a mobile device.

19. The optical tracking system of claim 2, wherein the plurality of light emitters comprises a first set of light emitters configured to emit visible light and a second set of light emitters configured to emit infrared light, wherein the at least one camera is configured to capture each of visible light and infrared light.

20. The optical tracking system of claim 19, wherein light emitted by at least one of the first set of light emitters and the second set of light emitters is based on an operational state of the at least one controller.

21. The optical tracking system of claim 1 further comprising a storage module configured to store at least one of the position and the orientation of the at least one controller, wherein the image processing module is further configured to determine at least one of a predicted position and a predicted orientation based on at least one of the position and the orientation.

22. The optical tracking system of claim 1, wherein the image processing module is configured to perform self-calibration of at least one of brightness and color associated with the at least one image.

23. An optical tracking system comprising:
a. a headset configured to be worn by a user;
b. at least one camera mounted on the headset;
c. at least one controller comprising a plurality of lasers, wherein the at least one controller is configured to receive at least one input; and
d. an image processing module configured to process at least one image of at least one of the at least one controller and a reflection of light emitted by the plurality of lasers on a surface, wherein processing of the at least one image is performed to detect at least one of a position and an orientation of the at least one controller, wherein the at least one image is captured by the at least one camera.

24. A method of optically tracking at least one controller, the method comprising:
a. receiving, using at least one camera, at least one image of the at least one controller comprising a plurality of light emitters arranged in a predetermined spatial pattern;
b. processing, using an image processing module, the at least one image to detect at least one of a position and an orientation of the at least one controller, wherein the processing is based on analysis of a projection of the predetermined spatial pattern in the at least one image; and
c. processing, using the image processing module, the at least one image to determine an operational state of the at least one controller, wherein the plurality of light emitters is configured to emit light corresponding to a plurality of colors, wherein the operational state is encoded in the plurality of colors.
